(19) United States
(12) Patent Application Publication
(10) Pub. No.: US 2012/0077175 A1
(43) Pub. Date: Mar. 29, 2012

(54) TIME-INDEXED DISCUSSION ENABLED VIDEO EDUCATION

(75) Inventors: John M. Levisay, Denver, CO (US); Josh H. Scott, Denver, CO (US); Andrew D. Rogers, Littleton, CO (US); Todd J. Tobin, Golden, CO (US); Bret S. Hanna, Denver, CO (US)

(73) Assignee: SYMPOZ, INC., Denver, CO (US)

(21) Appl. No.: 13/245,819

(22) Filed: Sep. 26, 2011

Related U.S. Application Data
(60) Provisional application No. 61/387,393, filed on Sep. 28, 2010.

(51) Int. Cl. G06F 3/01; G09B 3/00

(52) U.S. Cl. 434/322; 715/721

(57) ABSTRACT

A computer-implemented system and method for presenting video with time-indexed discussion comprising program instructions stored in memory. The program instructions are executable by a computer processor to store a video on a video server, and store at least one discussion on a database, each discussion being associated with a video time index. The video is streamed from the video server to a user device. At least one discussion is transmitted for display on the user's device when the video time is within a pre-specified range of the video time index for the discussion to be displayed.

### CROSS REFERENCE TO RELATED APPLICATION

This application claims the benefit of U.S. Provisional Application No. 61/387,393, filed on Sep. 28, 2010, the entirety of which is incorporated herein by reference.

### BACKGROUND

1. Field

This disclosure relates generally to video and threaded electronic discussions and, more particularly, to videos associated with time-indexed discussions.

2. Background

Video-based education is quickly becoming a major part of modern educational infrastructure. Several video-based solutions for conducting online educational lectures have been implemented. While many of these solutions incorporate streaming video, integrated student accounts and network-based examination and homework, none have managed to recreate the free-form discussions that take place in traditional classroom environments. Video-related discussions have been enabled on non-educational video streaming services (such as YouTube™), but they lack the capacity to generate the direct contextualized discussions, being mainly limited to one singular large discussion associated with the video.

### BRIEF SUMMARY

In one aspect of this disclosure, a computer-implemented system and method for presenting video with time-indexed discussion is disclosed herein. Program instructions are stored in memory. The program instructions executable by a computer processor to store a video on a video server, and store at least one discussion on a database, each discussion being associated with a video time index. The video is streamed from the video server to a user device. At least one discussion is transmitted for display on the user's device when the video time is within a pre-specified range of the video time index for the discussion to be displayed.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a high-level representation of the components involved in an illustrative implementation of a time-indexed discussion video educational system;

FIG. 2 is a flow chart illustrating a preferred sequence of steps for implementing the time-indexed discussion video educational system of FIG. 1;

FIG. 3 is a flow chart illustrating a continued preferred sequence of steps for implementing the time-indexed discussion video educational system;

FIG. 4 is a flow chart illustrating a continued preferred sequence of steps for implementing the time-indexed discussion video educational system;

FIG. 4A is a flow chart illustrating a continued preferred sequence of steps for implementing the time-indexed discussion video educational system;

FIG. 5 is a flow chart illustrating a continued preferred sequence of steps for implementing the time-indexed discussion video educational system;

FIG. 6 is a flow chart illustrating a continued preferred sequence of steps for implementing the time-indexed discussion video educational system;

FIG. 6A is a flow chart illustrating a continued preferred sequence of steps for implementing the time-indexed discussion video educational system;

FIG. 7 is a high-level representation of one embodiment of a user-interface for the time-indexed discussion video educational system;

FIG. 7A is a continuing high-level representation of one embodiment of a user-interface for the time-indexed discussion video educational system;

FIG. 7B is a continuing high-level representation of one embodiment of a user-interface for the time-indexed discussion video educational system;

FIG. 8 is a high-level representation of one embodiment of a user-interface dashboard for the time-indexed discussion video educational system;

FIG. 8A is a continuing high-level representation of one embodiment of a user-interface dashboard for the time-indexed discussion video educational system; and

FIG. 9 is a high-level representation of one embodiment of a user-interface showing an e-commerce time-indexed link.

### DETAILED DESCRIPTION

This application discloses a time-indexed discussion enabled video educational system and method. Among other things, the time-indexed discussion enabled video educational system allows an educational video presentation to replicate the free-form discussions of traditional live classroom lectures by introducing time-indexed discussion threads to video presentations. Because the discussions are indexed to a video-time of the video presentation, discussions can be linked to distinct lecture topics, duplicating, for example, the process by which students in live lectures ask questions mid-lecture, or how teachers interrogate students on topics via the Socratic method. Because the discussions are asynchronous, however, users still have the benefits offered by video-on-demand presentations, and are free to watch the video presentation and respond to discussion threads on their own time.

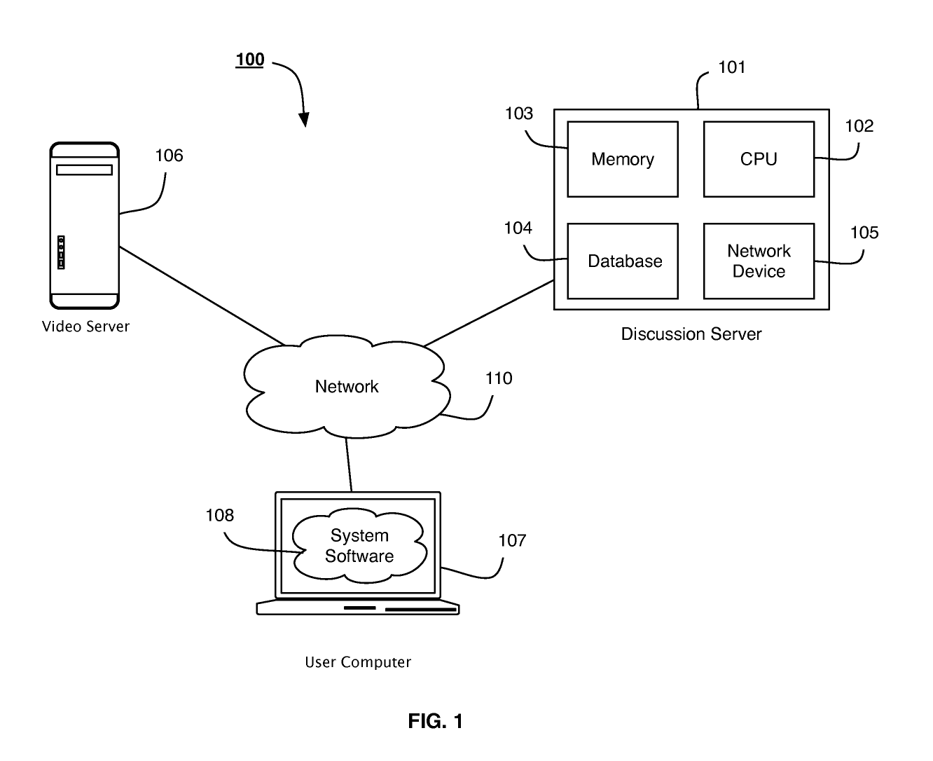

FIG. 1 is a high-level representation of the components involved in an illustrative implementation of the time-indexed discussion video educational system 100. The time-indexed discussion video educational system 100 may be implemented on a single computer, multiple computers, or on a computing cloud. The time-indexed discussion video educational system 100 may utilize software processes in conjunction with hardware. Preferably, the time-indexed discussion video educational system 100 may be implemented with a discussion server 101 (which is preferably a mix of hardware elements and software instructions), comprising a minimum of a central processing unit (“CPU”) 102, memory 103, database 104 and network device 105. The discussion server 101 preferably operates in conjunction with a video server 106 and with system software 108 operating on a user's computer 107.

CPU 102 is preferably provided to execute computer program instructions. Memory 103 may provide fast access random access memory (RAM) for fast storage and retrieval of computer program data to central processing unit 102. Database 104 may be provided for organization and storage of discussion threads and their constituent discussion posts, along with pertinent data relevant to implementation of the time-indexed discussion video educational system 100.

Pertinent data may include, for example, user identification, which may be associated with discussion thread posts by implementing instructor and user accounts. Third party accounts may also be implemented to enable, for example, editorial users. User accounts and identification may be stored on database 104. The identity of a posting party may be ascertained by requiring a standard “log-in” before any video viewing or discussion posting is allowed. Pertinent data may also include user associations, friendships and other social arrangements. For example, users may define for themselves other users they may wish to “add” as friends. Users may also organize themselves into peer groups of users according to their own preferences. Similarly, users may set preferences indicating users they would like to ignore. Other factors may be included as desired, such as age, course, personality, interests, level of activity, demographics, etc. The pertinent data may be utilized advantageously in a variety of ways, as will be seen below.

The discussion posts may be indexed to or otherwise utilize this pertinent data (such as a video-time or video segment) by way of database attributes associated with each post entry. Network device 105 may be provided for enabling communication to and from network 110. Network 110 is preferably a computer network, such as an intranet, extranet, wide or local area network, or preferably, the global Internet.

Video server 106 is preferably a computer-implemented system 100 for streaming video to users over network 110. Video server 106 may be implemented as any combination of computer hardware and software processes. As with the discussion server 101, the video server system 106 may also be implemented on a single computer, multiple computers, or on a computing cloud. It may also utilize software processes in conjunction with hardware. Video server 106 preferably streams information to other systems over network 110. While the video server 106 has been shown as a separate component from the discussion server 101, it is understood that both the video server 106 and the discussion server 101 may be implemented on a single computer system.

User device or computer 107 is preferably utilized by a user for viewing the streaming video transmitted over network 110 from the video server 106. Preferably, user device or computer 107 may comprise a personal computer system, such as a desktop system or a notebook computer. Computerized systems that enable networking and video display may also be utilized. Such systems may include (but are not limited to) smart-phones and tablet computing devices, for example, or televisions with built-in computing and networking capabilities.

System software 108 may be provided on the user device or computer 107 for retrieving and displaying video, discussion data, enabling video playback control and communicating user requests to the time-indexed discussion video educational system 100. Preferably, system software 108 may be integrated into an Internet browser, such as Internet Explorer™, FireFox™, Safari™ or any other typical Internet browser. System software 108 may, in such cases, take the form of a webpage with embedded video in some conventional format, such as (but not limited to) Flash™ or HTML5, and executable scripting, such as (but not limited to) JavaScript™. Alternatively, system software 108 may comprise a proprietary executable software program designed exclusively for use with the time-indexed discussion education system 100. Other formats may be implemented as desirable, including mobile and wireless device implementation and applications.

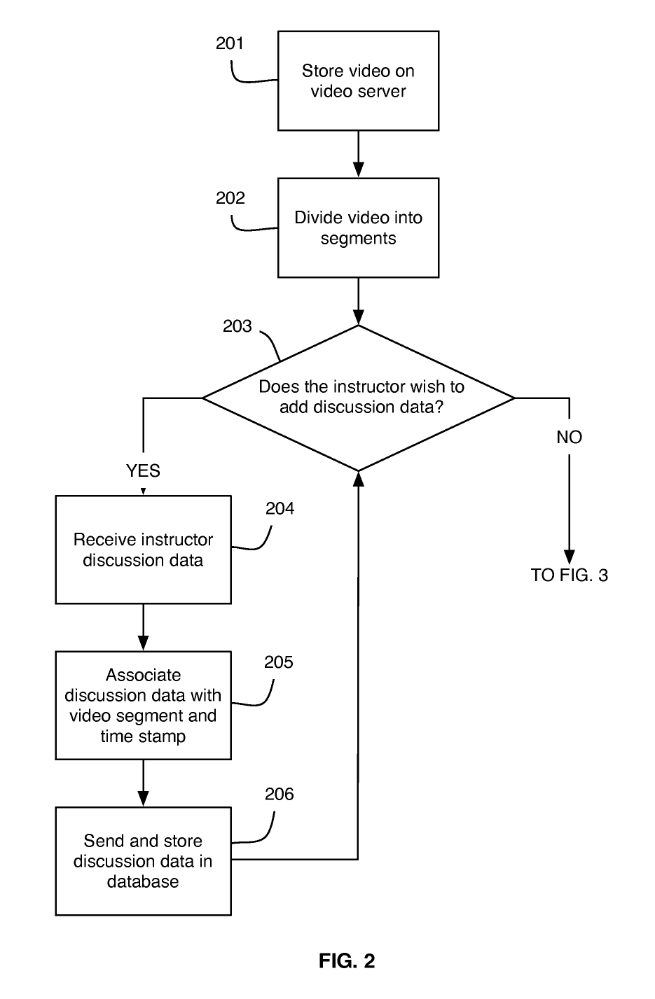

FIG. 2 is a flow chart illustrating a preferred sequence of steps for implementing the time-indexed discussion video educational system 100. In step 201, a video is preferably stored on video server 106 as preparation for streaming video presentation. Preferably, an instructor graphical user interface (“GUI”) is provided for educational instructors (such as teachers and professors) to set up lecture materials on the time-indexed discussion video educational system 100. The instructor GUI preferably includes functionality that allows an instructor to upload a lecture video onto the video server 106. In one embodiment, the instructor GUI may be implemented as part of system software 108, and may comprise, for example, a special instructor log-on webpage that requests authentication for instructor-based access to video server 106 and/or discussion server 101.

In step 202, the video may be divided logistically into segments. The instructor GUI preferably includes controls for dividing the lecture video into logical segments. Segments of the video may comprise topical divisions within the content of the video, such as distinct topics in an educational lecture. The GUI may enable this functionality by, for example, presenting the video with a displayed time-based progress bar, and allowing the instructor to insert divisions into the video manually via mouse input on the displayed time-based progress bar. Alternatively, more precise controls may be built into the instructor GUI. For example, the GUI may allow an instructor to manually type in a desired segmentation based on a video-time index, down to some predefined time sensitivity.

In step 203, the system preferably determines whether the instructor wishes to add discussion data to the video. Discussion data at this stage may take the form of a “first post” or a topical post. First posts preferably serve as a starting point for a discussion thread. Subsequent replies may be associated to the first post to generate a discussion thread comprising multiple posts, responses and sub-responses. This functionality preferably enables instructors to add time-indexed comments to video presentations, thereby mimicking, for example, Socratic method style questioning, or important commentary highlights to the video.

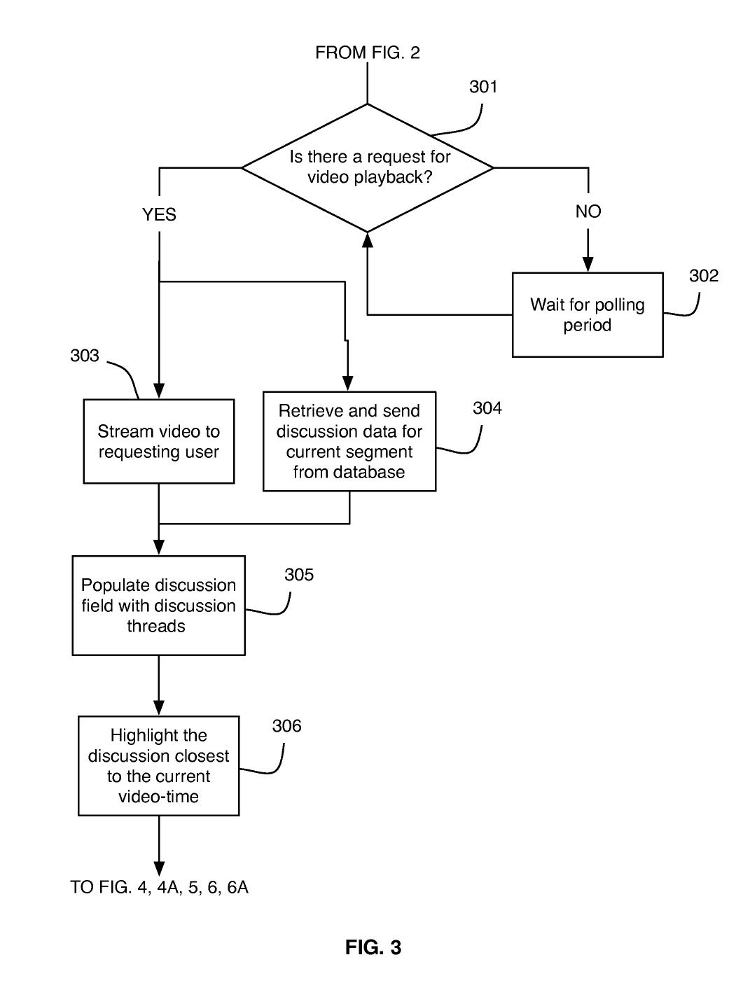

If the instructor does not wish to add discussion data to the video, the system may immediately progress to step 301 of FIG. 3. If the video instructor does wish to add discussion data to the video, then in step 204, system software 108 preferably receives inputted discussion data. Discussion data may be added to the video via use of the GUI. The GUI preferably provides a text input field (and preferably, text inputting tools) for inputting discussion data (such as (but not limited to) text, pictures, drawings, animations, movies, audio, files and other articles or other forms of media, as is now common on Internet “forums,” discussion groups and social networking systems), and the ability to associate the discussion data with a specific video-time. The input field may further include interactive or even collaborative input tools, such as a private or collaborative whiteboard. Once the instructor has completed inputting text and/or other discussion data, an input (such as a button or GUI) may be selected to indicate to system software 108 that the inputting of discussion data has been completed.

In step 205, the instructor may then associate the comment with a specific portion of the video. Preferably, this association involves at least associating the discussion data with a video-time index and a segment index. The video-time index may specify a specific time notation to which the video is tied. The video-time index may be set to a preferred sensitivity, depending on how accurate the time-indexed discussion video educational system 100 has been implemented. For example, a one hour long video may have sixty indices if the index sensitivity is set to a single minute. The same video may have three-hundred sixty indices if the index sensitivity is set to a single second. Any desirable implementation is acceptable. The segment index may be assigned automatically once the video-time index has been selected, if the video is divided into segments earlier as described above (step 202). If not, the segment index may also be assigned manually.

In step 206, once the instructor has completed inputting the desired instance of discussion data, the system software 108 preferably receives the instructor discussion data and transmits it to database 104 for storage. System software 108 preferably encapsulates the information in a storable and transmittable packet, which may be sent by user computer 107 over network 110. The packet may then be received by network device 105, whereupon CPU 102 may extract the discussion data (i.e., the post), video-time index and segment index (if applicable). CPU 102 may then generate an entry in database 104 and store the discussion within that entry, along with information identifying the specific video, video-time index and segment index the data should be associated with.

After step 206, the system may return to step 203 to determine whether the instructor wishes to add additional discussion data. This process may then be repeated for as many discussion posts the instructor may wish to add. Once the instructor has completed inputting discussion posts, the method may progress to step 301 of FIG. 3. It should be noted that the instructor is not limited to inputting discussion posts only during the initial set up of the video. The instructor is preferably able to input discussion posts at any time thereafter by accessing the system software 108. Once the instructor has completed adding discussion data (or if the instructor elected not to add any discussion data to start with), the system may proceed to FIG. 3 (see below).

FIG. 3 is a flow chart illustrating a continued preferred sequence of steps for implementing the time indexed discussion video educational system 100. In step 301, the time-indexed video educational system 100 may wait for a request to begin video playback. Users preferably access the time-indexed video educational system 100 through system software 108, which communicates with video server 106 and database server 101 over network 110. When users wish to access a video, they may navigate to the appropriate webpage and click on a desired link directing them to the video. Accessing the link preferably causes system software 108 to generate requests to video server 106 and discussion server 101. Preferably, both video server 106 and discussion server 101 continually monitor incoming network traffic to determine for requests. If no request exists, then in step 302, both video server 106 and discussion server 101 preferably wait for a polling period before querying whether such a request exists again.

Once a request is detected, then in step 303, the video server 106 preferably retrieves the requested video from storage and streams the requested video to user device or computer 107 over network 110, in addition to any information associated with the video stored on the video server 106 (such as segment information). The video may then be displayed on user computer 107 through system software 108. Buffering, quality reduction and other video streaming techniques may be used to ensure adequate playback of the video on user computer 107.

Simultaneously, in step 304, system software 108 may retrieve discussion data pertinent to the requested video from the database server 101. Preferably, as described earlier, the video is broken or otherwise divided into segments. System software 108 may therefore retrieve the discussion data relevant to the currently viewed segment of the video being displayed on user computer 107. System software 108 may send video identification and segment data to system software 108 over network 110. CPU 102 may then retrieve discussion data from database 104, including associated video and segment information matching the received video identification and segment data. The retrieved discussion data may then be encapsulated and transmitted through network device 105 over network 110 to user device or computer 107, where it may be received by system software 108.

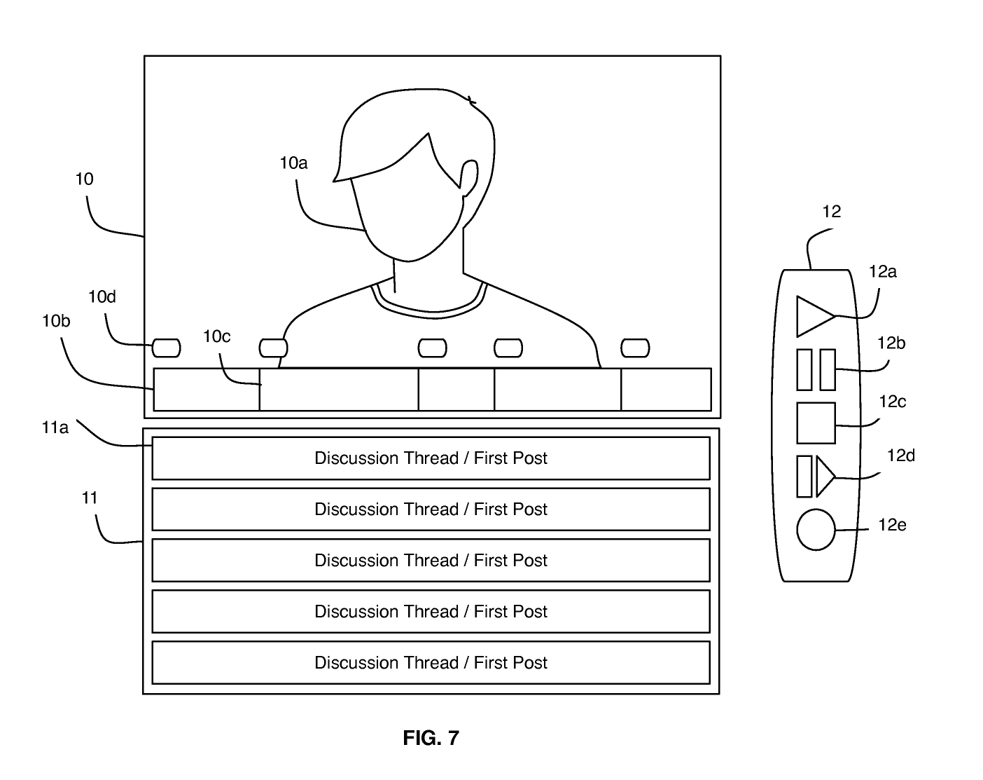

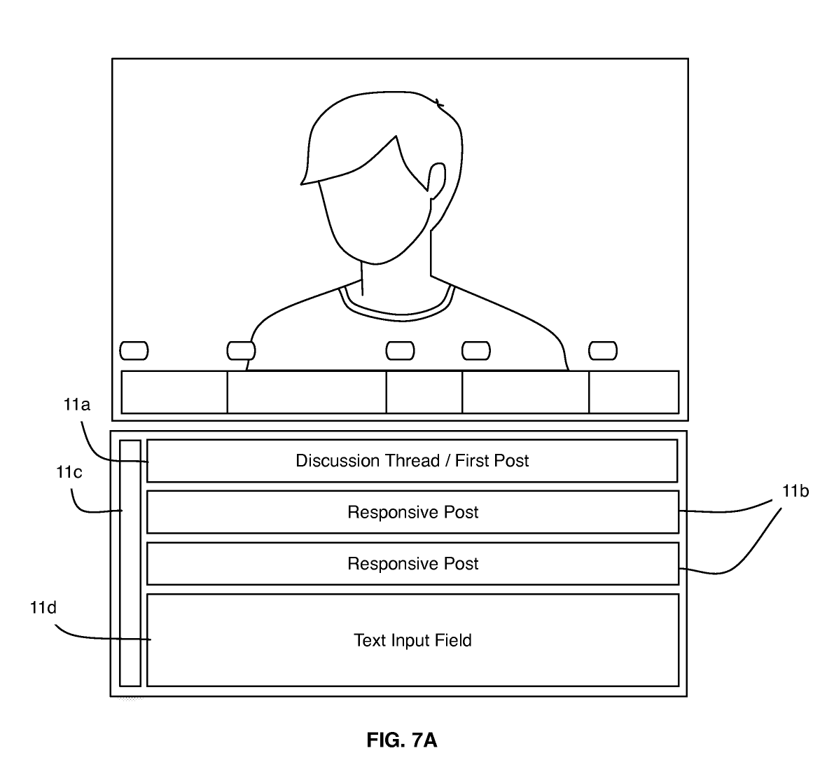

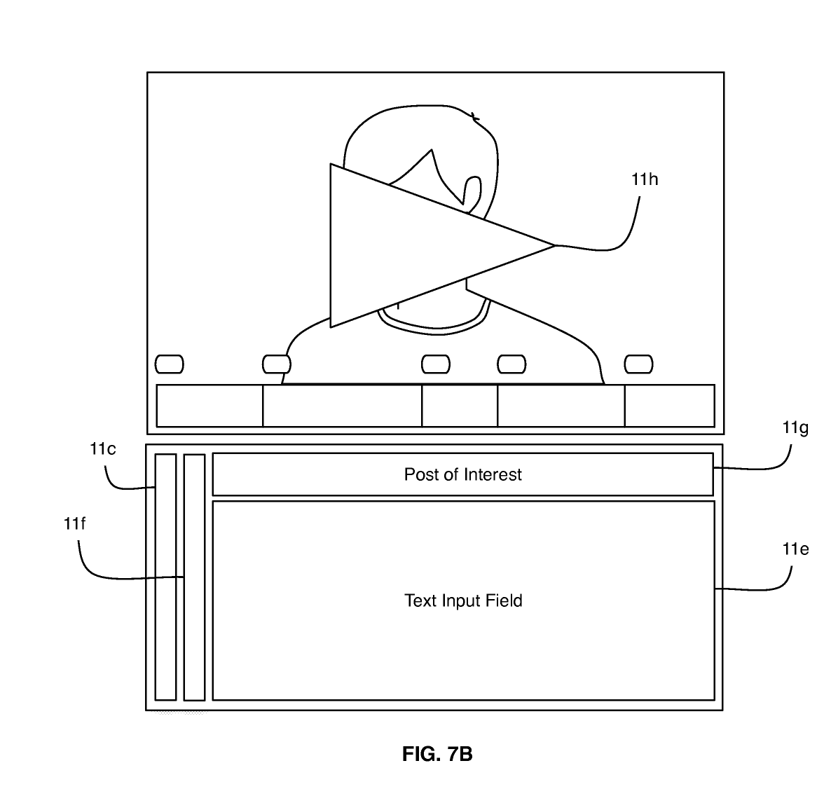

In step 305, system software 108 preferably populates the GUI with information from the received discussion data. As will be described below (in FIGS. 7, 7A and 7B), this may include indicators on a video time bar showing the time-indexed location of the comments, and a text-based field displaying, for example, the first post in each discussion thread. Furthermore, as will be described below, the order in which the field is populated may be determined by a number of factors to present a more attractive or useful display.

In step 306, the discussion having the closest video-time index to the current video-time of the streamed video is preferably highlighted on the GUI. System software 108 may determine which discussion thread to highlight by comparing the current video-time to the video-time indices of all topical posts of the received discussion data. The closest match is then preferably highlighted. Highlighting preferably indicates to the user which discussion is most pertinent to the current content of the streamed video, and may, for example, take the form of a noticeable graphic effect.

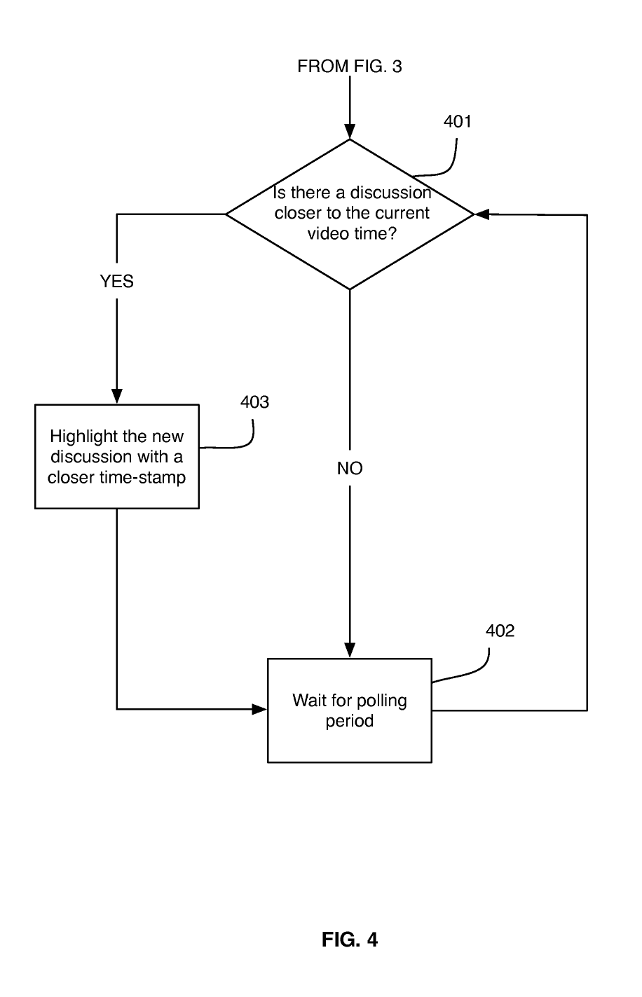

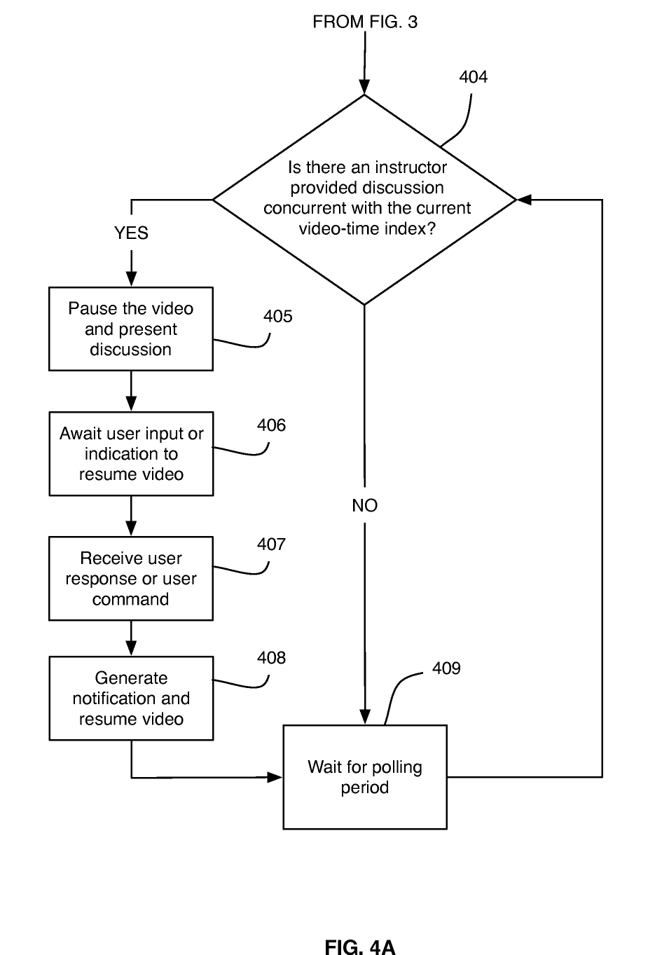

Subsequently, the time-indexed discussion video educational system 100 preferably executes at least four separate processes concurrently, and therefore preferably simultaneously progresses to steps 401, 404, 501, 601 and 607 of FIGS. 4, 4A, 5, 6 and 6A. These will be discussed in turn.

FIG. 4 is a flow chart illustrating a continued preferred sequence of steps for implementing the time-indexed discussion video educational system 100, showing a preferred process for maintaining the highlighting on the most relevant discussion to the current video-time. In step 401, system software 108 preferably examines the video-time indices of each “first post” out of the received discussion data (from step 304). Each video-time index may be compared to the current video-time of the video to determine whether there is another discussion with a closer video-time index (relative to the currently highlighted discussion). If there is not, then in step 402, the system software 108 may wait for a polling period before repeating the query under step 401. If there is, then in step 403, system software 108 preferably highlights the new discussion thread determined to have the closest video-time index. Subsequently, the system software 108 may wait for a polling period under step 402, before repeating the query. This preferred method ensures that the most relevant discussion thread is always highlighted, based on the video-time index.

FIG. 4A is a flow chart illustrating a continued preferred sequence of steps for implementing the time-indexed discussion video educational system 100, detailing a preferred process by which interruptive discussions may be implemented. In step 404, the system software 108 may determine whether an instructor-provided discussion “first post” has a video-time index concurrent with the current video-time index for the video. If there is not, then in step 409, system software 108 preferably waits for a polling period before repeating the query. If there is, then in step 405, system software 108 preferably pauses playback of the video and presents the user with the instructor-provided discussion thread. In step 406, the system may await either user input or a user indication to resume the video. As with standard reply posts to discussion threads, user input may take the form of a text-based reply post, which is stored in database 104 of discussion server 101 as a post responsive to the discussion thread anchored by the instructor-provided “first post.” Once system software 108 receives and completes storing the user response, or if it receives a command to resume the video, then in step 408, system software 108 preferably generates an automatic notification and resumes playback of the video. The automatic notification may comprise, for example, a notification in the instructor's instance of system software 108, or it may be sent to an external account, such as (but not limited to) a text message (preferably sent via a Short Message Service (SMS), Multimedia Messaging Service (MMS) or any other suitable messaging service), e-mail or any other avenue of communication available. Subsequently, in step 409, the system may await a polling period before repeating the query of step 404. When video viewers begin responding to the discussion threads generated by the instructor, notifications may automatically be generated to notify the instructor and fellow students that a new response has been posted to one of his discussion threads. Notably, a response to the notification may be set to automatically create a corresponding response in the discussion thread.

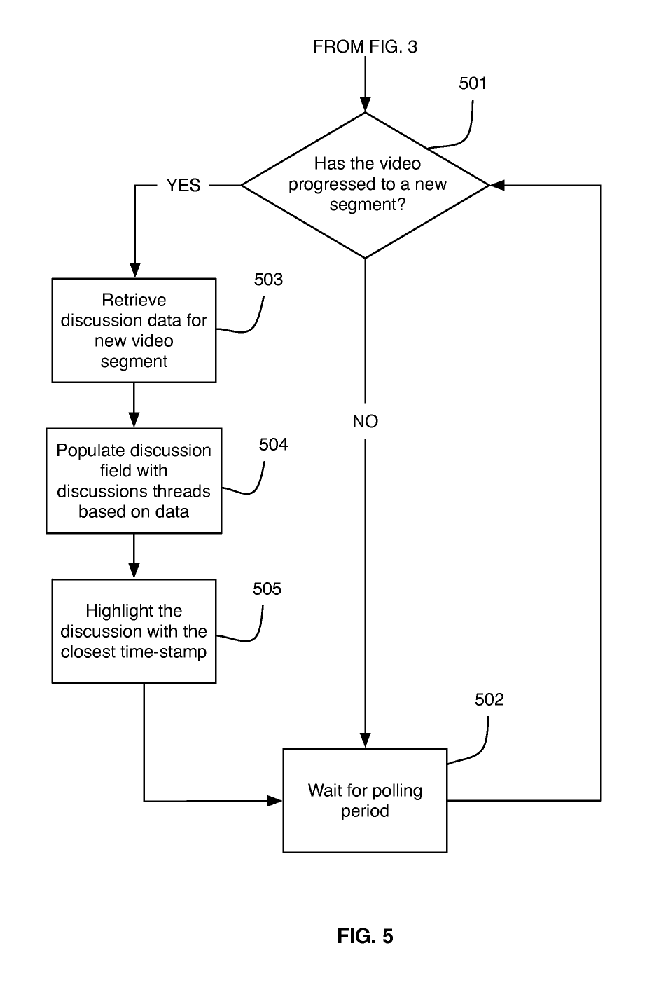

FIG. 5 is a flow chart illustrating a continued preferred sequence of steps for implementing the time indexed discussion video educational system 100, detailing a preferred process for retrieving new discussion data when the video progresses to a new segment. In step 501, the system software 108 may determine whether the streaming video has progressed to a new segment based on the segment information received previously (in step 303) and the current video-time. Segment information preferably contains a video-time index marking the boundary between one segment and another. A comparison of the current video-time to the boundary video-time with respect to the last known segment may enable system software 108 to determine whether the video has progressed to a new segment.

If the video has not progressed to a new segment, then the system preferably waits for a polling period in step 502, before repeating the query. If the video has progressed to a new segment, then system software 108 preferably sends a request for new discussion data corresponding to the new video segment from the discussion server 101 in step 503. CPU 102 may then retrieve discussion data (including associated video identification and video segment information corresponding to the video being streamed) corresponding to the requested video segment from database 104 of discussion server 101. The relevant discussion data may then be transmitted back to user computer 107 through network 110.

Upon receiving the information, in step 504, system software 108 may populate a field on the GUI with the received discussion data (the actual format of which will be described further below). In accordance with FIG. 4, in step 505, the system software 108 may highlight the discussion from the newly received discussion data having the closest video-time index to the current video time, or other parameters. Subsequently, in step 502, system software 108 may wait for a polling period before returning to the step 501. In this fashion, the system software 108 may continue monitoring whether the video has moved to a new segment and new discussion data is required.

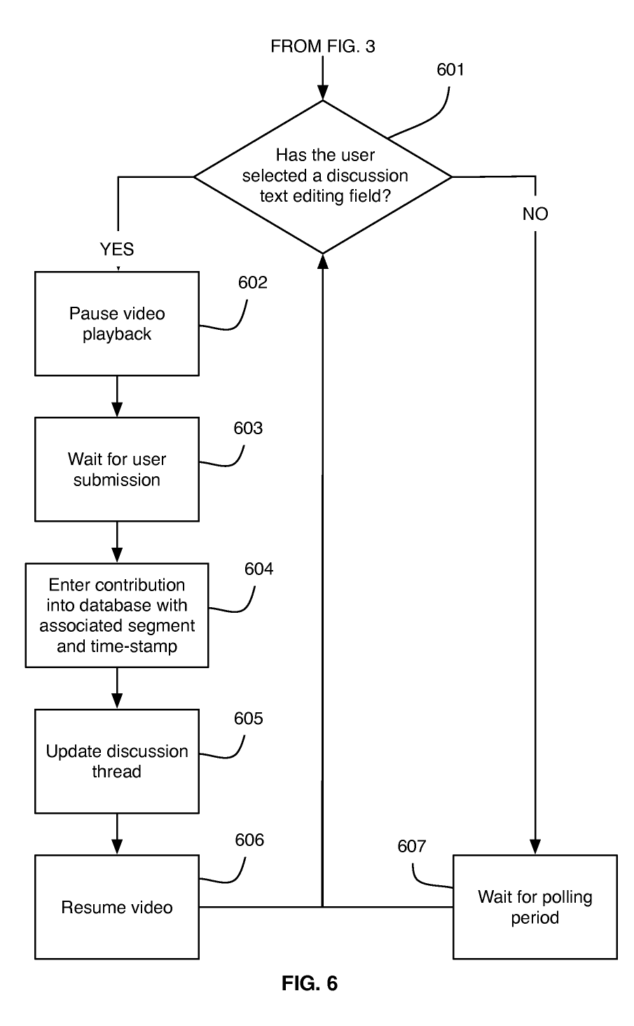

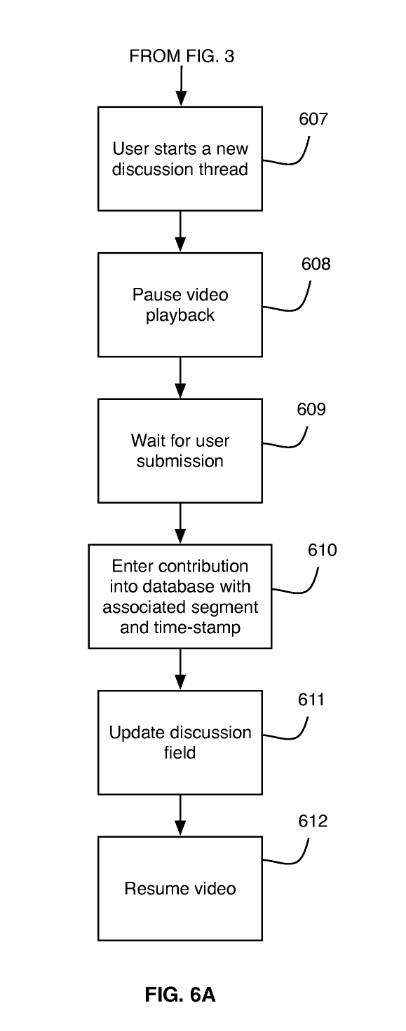

FIG. 6 is a flow chart illustrating a continued preferred sequence of steps for implementing the time-indexed discussion video educational system 100, detailing a preferred process by which playback may be paused while a user replies to an active discussion. In step 601, system software 108 may determine whether the user has selected a discussion text-editing field on the GUI. If the user has not selected a discussion text-editing field, then in step 607, system software 108 preferably waits for a predetermined polling period before repeating the query in step 601.

If the user does select a discussion text-editing field, then in step 602, video playback is preferably paused. This may preferably give a user time to think and respond to a discussion thread without concern over missing part of the video presentation due to inattention. The input, which may include (but is not limited to) text, files, video, audio, photographs, drawings, white board, etc., may be entered into a text field display via the GUI of system software 108. In step 603, system software 108 preferably waits for the user submission before taking any further action.

In step 604, the system software 108 may receive an indication that the reply is complete, and initiate sending of the reply data to discussion server 101 for storage in database 104. A user may indicate that the reply is complete by, for example, selecting a provided submission button in the GUI of system software 108. In response, user computer 107 preferably encapsulates the data, along with any pertinent information (such as the discussion thread to which it belongs and a video-time index), and transmits the information over network 110 to the discussion server 101, where it is received through network device 105. CPU 102 may then retrieve the content of the reply along with any associated information (such as the video-time index and video segment) and store it within a new entry in database 104, associating it with the parent post to which it is replying.

In step 605, once system software 108 receives confirmation of successful storage of the new reply post from discussion server 101, the discussion thread may be updated within the GUI so that the user sees the reply added to the thread. In step 606, playback of the video may resume. Subsequently in step 607, system software 108 preferably waits for a polling period before repeating the query of step 601.

FIG. 6A is a flow chart illustrating a continued preferred sequence of steps for implementing the time-indexed discussion video educational system, describing a process by which a user watching a video may create a new discussion thread. In step 607, a user (which may include the instructor, a student, or a third party) may initiate creation of a new thread by selecting a “start discussion” button on the GUI of system software 108. New discussion threads may be utilized for a variety of purposes, including (but not limited to) asking questions about the current video topic, or inserting comments relevant to the current video topic. For example, a user who has a question may start a public discussion thread, whereupon other students and/or the instructor may respond to the new thread to answer his question. A user may also start a private discussion thread viewable only by himself or by a selected group of people, to serve as a targeted discussion amongst a small group of people, or to take and/or share notes on the video. In step 608, system software 108 preferably pauses video playback of the video to ensure that the user does not miss a portion of the video presentation while he is busy creating the new submission. In step 609, system software 108 preferably waits for the user to complete his submission, which may take the form of text input. Other inputs, such as graphical, voice and video inputs, are also contemplated.

Once the submission is complete, the user may indicate this to system software 108 by selecting an appropriate button on the GUI. Then, in step 610, system software 108 preferably encapsulates the entry along with any pertinent data (such as the originating user, the video-time index and/or video segment, etc.), and transmits the data over network 110 to discussion server 101, where it may be stored on database 104 as a new database entry. Subsequently, in step 611, once system software 108 has received confirmation that the entry has been stored, the GUI discussion field may be updated to reflect the presence of the user's discussion thread. Finally, in step 612, playback of the video may automatically resume.

FIG. 7 is a high-level representation of an illustrative user-interface for the time indexed discussion video educational system 100, illustrating one embodiment of a GUI for the system software 108. The GUI preferably includes a video display area 10, which may be utilized for displaying a video 10a. Video display area 10 may also include a video status bar 10b, which is preferably a visual depiction of the chronological progression of the video 10a. Segment indicators 10c may populate the video status bar 10b, marking the divisions between one video segment and the next video segment. Finally, discussion indicators 10d preferably serve to illustrate where discussions are indexed along the video status bar 10 according to each discussion's associated video-time index.

Discussion display area 11 is preferably provided for display of discussion threads, which may include student-created discussion threads, instructor-created discussion threads, or private or semi-private discussion threads, as described above. Discussion threads 11a may be represented visually in discussion display area 11. Preferably, only the first post of each discussion thread is displayed to prevent overcrowding of information. Discussion threads 11a may be indexed to the video status bar 10b via the video-time index of the first post of the discussion thread.

The discussion threads 11a may be sorted to enable easier viewing of the available discussions. Discussion threads 11a may be sorted according to any combination of pertinent data factors associated with user accounts and discussion threads stored in database 104. As described above, pertinent data may include information such as user preferences, level of activity, demographics, friendships, peer groups, age, courses taken, a directive to ignore a certain user, a popularity/recommendations feature, etc. Any algorithm for sorting discussion threads 11a may utilize any one or more of these factors to perform the sorting function, and present a more organized, attractive or relevant order of discussion threads to a viewing user. For example, a sorting algorithm prioritizing user friendships may situate discussion posts generated by the viewing user's friends higher in the discussion thread field. The algorithm may also hide discussion posts generated by users whom the viewing user has chosen to ignore. Alternatively, discussion threads may be ordered according to a “popularity” or “recommendations” feature. For example, if a particular discussion thread is found to be useful, or poses a question a user is also curious about, the viewing user may “tag,” “like,” “recommend” or otherwise notate the discussion thread. Discussion threads that have more notations may be prioritized higher by the sorting algorithm. In sum, the sorting algorithm may account for any factor or combination of factors to sort the list of discussion threads as desired.

Video control area 12 may be provided to centralize control of video playback and use of GUI options. Video control area 12 may be equipped with standard video control functions, such as (but not limited to) play button 12a, pause button 12b, stop button 12c, next segment/chapter button 12d, and previous segment/chapter button 12e. One or more additional buttons for additional functionality may be included as desired. For example, a “start discussion” button may be provided for inserting a new discussion thread to the video rather than reply to an existing one. When the “start discussion” button is selected, the system software 108 may receive user text input, associate it with a video-time index (and possible segment information), and transmit it to discussion server 101 for storage in database 104 as a “first post” anchoring a new discussion thread. As above, during the creation process, playback of the video preferably pauses. A “menu” button may also be provided for accessing standard file, edit and view menu functions of system software 108. Scrolling buttons may be provided for moving a highlight cursor between discussion threads. An enter button may be provided for selecting a highlighted discussion thread.

FIG. 7A is a continuing high-level representation of the preferred user-interface for the time indexed discussion video educational system 100, illustrating the status of the graphical user interface of system software 108 after the user has selected one of the discussion threads 11b from FIG. 7. Once a user has selected a discussion thread 11a, other discussion threads are preferably removed from display. In their place, responsive posts 11b to the discussion thread 11a are displayed so the user can read the full discussion. The previous menu (containing only the discussion threads 11a, as illustrated in FIG. 7) may be retrieved by accessing a return menu bar 11c, which preferably reverts the discussion display area to the configuration of FIG. 7. Scroll bars and/or arrows (not shown) may be included if the full discussion thread is too large to be contained in the available display area. Text input field 11d is preferably provided for entering responsive posts to the discussion thread 11a. Text input field 11d may include functions, buttons and other command inputs for specialized text input, such as (but not limited to) formatting and font functions (e.g., bold, italic and underline), paragraph and spacing configuration, outlining and lists, etc. If text input field 11d is selected by the user, playback of the video 10a preferably pauses to allow the user to input a response, as described above (FIG. 6).

FIG. 7B is a continuing high-level representation of a preferred user-interface for the time-indexed discussion video educational system 100, illustrating the status of the GUI of system software 108 after the user has selected to respond to a specific post (such as the first post 11a or responsive posts 11b). The post of interest 11g (i.e., the post to which the user is responding) may be moved to the top of the discussion display area 11. An expanded text input field 11e may occupy the remainder of discussion display area 11, as there is no need to display the other remaining response posts, since they are no longer of interest. The larger area of text input field 11e may make text input easier for the user. A second return menu bar 11f may be provided as a means of returning to the GUI configuration of FIG. 7A. The first return menu bar 11e is preferably still visible to allow fast return to the GUI configuration of FIG. 7. Finally, a resume play button 11h may be displayed over the video 10a to allow resumption of video playback. Additionally, completion and submission of an inputted responsive post may automatically resume video playback.

Other types of inputs may be utilized besides text input via computer for discussion thread posts. For example, text may be accepted from other computer-based services, such as (but not limited to) Short Message Service (“SMS”), e-mail, instant messenger, social networking websites, etc. Additionally, formats beyond text are contemplated. Video and audio responses may be utilized for an even closer approximation of classroom communication. Simpler media responses may also be used, such as pictures and animations. Sources and materials related to responses may be stored and attached to discussion thread posts for download by other users. Instead of Socratic method questioning, pop quizzes may be inserted into the video presentation by enabling multiple-choice selection. Polls may be conducted using multiple-choice selection as well.

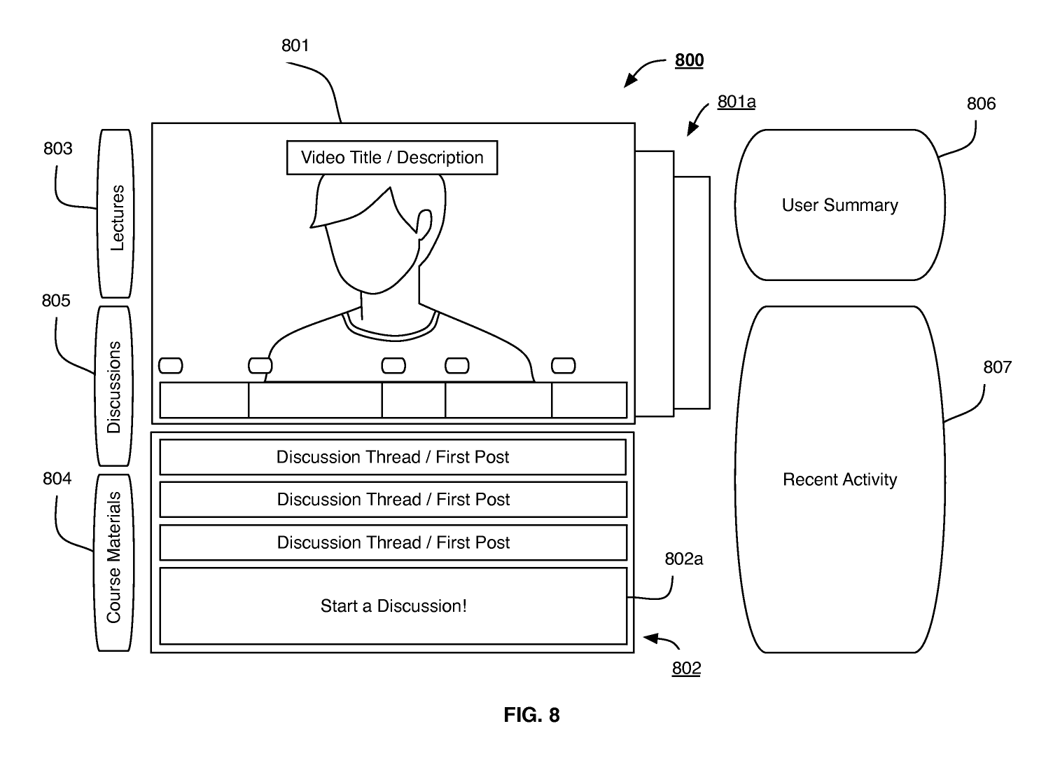

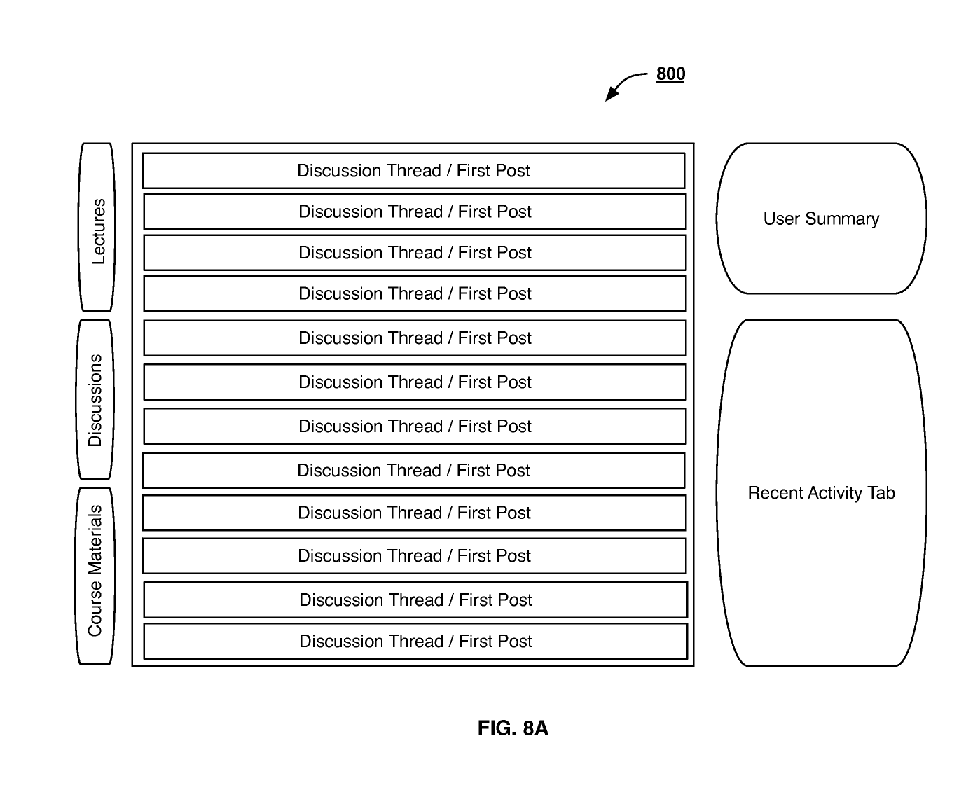

FIG. 8 is a high-level representation of one embodiment of a GUI dashboard 800 for the time-indexed discussion video educational system. Dashboard 800 may serve as an entry point for users when they first access the time-indexed discussion video educational system via system software 108. Video-links 801 may graphically display the first of a series of videos links, including an image-still from the video, video title and/or a description, giving users an indication of the content contained within the linked video. Subsequent video-links 801a may be displayed graphically behind and adjacent to a “first” video-link 801. Clicking on a subsequent video-link 801a preferably moves the selected video-link to the forefront as a “first” video-link 801, thereby giving the user a preview image-still, video title and/or description for the selected video. Selecting the “first” video-link 801 preferably initiates video playback (generating the view seen in FIG. 7). System software 108 preferably tracks a user's video history and automatically displays the first unwatched video in a series of videos as the “first” video-link 801

Discussion pane 802 preferably displays discussion threads related to the “first” video-link 801. This may enable a viewing user to develop a general sense of the discussions, concerns and questions currently being asked with respect to the relevant video. A “start discussion” button 802a may be provided as well, enabling a user to start a discussion within the video without necessarily needing to view the video presentation. This may be beneficial in situations where the student has already viewed the video lecture and wishes to start a discussion topic without needlessly viewing the video again. Alternatively, this may also benefit students who have questions regarding the topic even before watching the video. Preferably, the GUI contains functionality allowing the user to associate a discussion created in this manner with a segment or video-time index manually. Additionally, when selecting a discussion thread in discussion pane 802, users preferably have the option to “jump” to playback of the associated video and the relevant video-time for the selected discussion. Users may benefit from this if they have forgotten or are unsure of the topical context of the selected discussion.

Tab-links 803, 804 and 805 may serve as easy access to core functions of the dashboard 800. Lecture tab 803 preferably links the user to the view depicted in FIG. 8, where lecture videos are prominently represented, enabling the user to quickly preview and select a lecture video for viewing. Course Material tab 804 preferably alters the configuration of dashboard 800 to display a course document view. The course document view may display core course documents, such as a syllabus, lecture and exam schedule, grade book, and other typical course materials. These and other types of course materials, such as instructor notes, syllabi, topical outlines, etc. may be indexed to the video time indicated by the video status bar 10b as well. For example, instructor note materials (such as Adobe PDF® files) may be indexed to video times according to their relevance to the video segment, giving students quick and contextual access to class materials.

User Summary field 806 may present a quick overview of the viewing user, including information such as user name, graphical avatar and other statistics. For example, if a “follow” function is implemented, a count may be displayed showing the number of other users “following” the comments of the viewing user. If a mail system is implemented within the time-indexed discussion video education system, the number of new mail entries may be displayed. If an accolade system (such as the “like” function on Facebook™, or the “e-prop” system on Xanga™) is implemented, the total number of accolades to date accumulated by the viewing user may be displayed here.

Recent Activity field 807 may display activity by other users. As with the discussion fields described above, this information may be sorted or filtered in any manner desirable, based on any factor or combination of factors that has been implemented. Preferably, the Recent Activity field 807 may simply display activity from other users enrolled in the same courses as the viewing user. Alternatively, the field may be sorted or filtered based on user preferences and pertinent data, such as the instruction to ignore a particular user (in which case the offending user's posts would be hidden in the field). Any implementation of the Recent Activity field 807 is acceptable.

Discussion tab 805 preferably alters the format of dashboard 800, shifting it to the configuration seen in FIG. 8A. FIG. 8A is a continuing high-level representation of one embodiment of a user-interface dashboard for the time-indexed discussion video educational system, illustrating a configuration of dashboard 800 where discussion threads are prominently displayed. Removing the video-links 801 and 801a preferably enables a larger number of discussion threads to be displayed. This may make quick review of discussion threads easier for a viewing user. As described earlier, the discussion threads may be sorted to enable easier viewing of the available discussions. Again, as above, different methods of sorting may be utilized, and may consider any user preferences or pertinent data factors, such as level of activity, demographics, friendships, peer groups, age, courses-taken, a directive to ignore a certain user, etc.

Notably, dashboard 800 may also comprise a special “instructor” view, which is preferably exclusive to instructors. While visually similar to the standard dashboard 800, the instructor view may include additional or alternative functionality, such as the ability to add interruptive questions (as described in FIG. 2 and FIG. 4A) to video playback. The instructor view dashboard 800 may also include additional functionality for sorting discussions. Sort factors such as friendships, common courses or peerage may not be as useful for an instructor (although they may certainly be implemented if desired), due to his role as a teacher and the resulting relationship he has with his students. Therefore, a priority-based sort may be implemented instead. Priority-based sorting preferably enables an instructor to respond to high-priority questions first, so that an instructor who is otherwise unable to respond to all questions may benefit students as much as possible even with a limited number of responses. Priority may be based on one or more factors, such as the number of posts in a thread, the rapidity by which a thread generates posts, the number of unique users posting in a thread, etc. The factors utilized preferably indicate or at least imply that many users are having difficulty understanding a particular concept being discussed. Other factors may be considered. For example, the instructor may preemptively add pertinent data indicating that a particular topic (as indicated by video-time index or segment) is difficult. Discussion threads involving the flagged topic (via the pertinent data) may therefore be prioritized automatically in the instructor dashboard 800 view. As with the standard dashboard 800 above, it may be possible to select a discussion thread and automatically “jump” to playback of the appropriate video-time index and/or segment of the relevant video.

Besides students and instructors, third party users may partake in creating or participating in video discussions as well. A third party responsible for managing the time-indexed discussion video educational system may utilize discussion data to add, for example, editorial content to videos. The system is preferably flexible enough to accommodate any type of commenter and any type of comment, according to the requirements of the end-users.

The implementation of friendships, classes, groups or other social associations as pertinent data may be used to control the privacy of discussion threads. For example, a user may start a discussion thread, but dictate that the discussion thread should be visible only to a limited set of users. This may be implemented by attaching privacy-indicator data to discussion post entries stored on database server 101. For example, if an initial user indicates that a discussion thread “first post” should be visible only to friends, then a check on database server 101 may be made between accessing users and the initial user's friend list (which may also be stored on database server 101). If the accessing user is not a member of the initial user's friend list, database server 101 preferably withholds sending that particular discussion post to the accessing user's computer 107. These steps may alternatively be performed on user computer 107 by system software 108 (in which case the friend list and discussion data must be requested from discussion server 101 before any comparison may be performed). Once again, if the accessing user does not appear on the initial user's friend list, system software 108 may decline to render the relevant discussion post for viewing. Any factor or combination of factors may be utilized to implement discussion thread privacy.

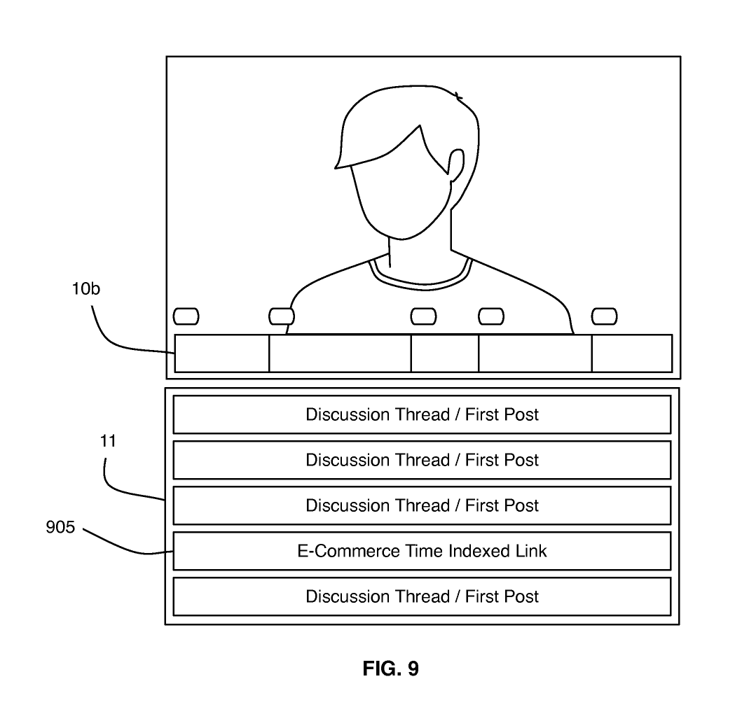

FIG. 9 is a high-level representation of one embodiment of a user-interface showing an e-commerce time-indexed link 905. Relevant e-commerce time-indexed links may be indexed to video times on the video status bar 10b, just as relevant discussion threads are indexed to the video time indicated by the video status bar 10b. For example, a video segment discussing materials for crafting an article of clothing may have an e-commerce time-indexed link 905, linking the user to the materials necessary to craft the article of clothing being discussed. Accessing the link would direct the user to, for example, an internal or external website where the advertised materials are available for purchase.

A standard search function may be implemented to enable user-based searches of discussion threads, lecture topics, notes and any other searchable information associated with educational videos hosted on the time-indexed discussion enabled video educational system 100. Users would input a searchable text string (in addition to standard search arguments and parameters). Relevant search results may be returned to the user, who may then select the desired search result.

As discussed above, the time-indexed discussion video educational system 100 may be implemented utilizing one or more computing systems of varying configurations. For instance, the computing systems may be combined as a single computing system. Each computing system preferably includes computing components for executing computer program instructions and processes. These components may include a central processing unit (CPU), memory, input/output (I/O) devices, and a network interface.

The CPU processes and executes computer program instructions. Random access memory (RAM) and/or fast access cache memory preferably provides fast data supply to CPU. Long-term storage may be provided as a more permanent form of computer memory, and may be, for example, a hard disk, optical disk, flash memory, solid-state memory, tape, or any other type of memory.

The I/O device(s) permit human interaction with the computer system, such as (but not limited to) a mouse, keyboard and computer display. I/O device(s) may also include other interactive devices, such as (but not limited to) touch screens, digital stylus, voice input/output, etc.

The network interface device may provide the computing system with access to a network, which may be a wireless or wired connection. The network may be, for example, the Internet, a corporate intranet, or any other computer network through which the computing system may connect to or otherwise communicate with other computers and any other databases represent other computerized systems or databases for specialized information that may be necessary for implementation of the integrated computing system and computer-implemented method for record archive disposition.

Software process or processes and executables (such as system software 108, for example) on the computing system may be used to provide human interfaces (such as a graphical user interface), and to store and initiate computer program instructions used to process and analyze data. Computer program code for carrying out operations described herein may be written in any combination of one or more programming languages, including an object oriented programming language such as Java, C++, C# or the like and conventional procedural programming languages, such as the “C” programming language or similar programming languages. The program code may execute entirely on the computing system, partly on the computing system, as a stand-alone software package, partly on the computing system and partly on a remote computer or server, or entirely on a remote computer or server.

This application was described above with reference to flow chart illustrations and/or block diagrams of methods, apparatus (systems) and computer program products according to one or more embodiments. It is understood that some or all of the blocks of the flow chart illustrations and/or block diagrams, and combinations of blocks in the flow chart illustrations and/or block diagrams, can be implemented by computer program instructions. The computer program instructions may also be loaded onto the computing system to cause a series of operational steps to be performed on the computer to produce a computer implemented process such that the instructions that execute on the computer provide processes for implementing the functions/acts specified in the flowchart and/or block diagram block(s). These computer program instructions may be provided to the CPU of the computing system such that the instructions, which execute via the CPU of the computing system, create means for implementing the functions/acts specified in the flowchart and/or block diagram block(s).

These computer program instructions may also be stored in a computer-readable medium that can direct the computing system to function in a particular manner, such that the instructions stored in the computer-readable medium implement the function/act specified in the flowchart and/or block diagram block or blocks. Any combination of one or more computer usable or computer readable medium(s) may be utilized. The computer-usable or computer-readable medium may be, for example (but not limited to), an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory, a read-only memory, an erasable programmable read-only memory (e.g., EPROM or Flash memory), an optical fiber, a portable compact disc read-only memory, an optical storage device, a transmission media such as those supporting the Internet or an intranet, or a magnetic storage device. Any medium suitable for electronically capturing, compiling, interpreting, or otherwise processing in a suitable manner, if necessary, and storing into computer memory may be used. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including (but not limited to) wireless, wire line, optical fiber cable, RF, etc.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A video educational system, comprising:
a database;
a video server;
a processor; and
program instructions stored in memory, wherein the program instructions are executable by the processor to:
store a video on the video server;
store at least one discussion on the database, each discussion being associated with a video time index;
stream the video from the video server to a user device; and
transmit at least one discussion for display on the user's device, each discussion being displayed when the video time is within a pre-specified range of the video time index for the discussion to be displayed.

2. The system of claim 1, wherein the program instructions further comprise:
receiving at least one response to the discussion; and
appending the response to the discussion.

3. The system of claim 1, wherein the program instructions further comprise setting the pre-specified range to correspond to a video segment topic.

4. The system of claim 3, wherein the program instructions further comprise associating the discussion with the video segment topic when the discussion relates to the video segment topic.

5. The system of claim 3, wherein the program instructions further comprise:
retrieving from the database all discussions associated with a currently playing video segment topic of the streaming video; and
transmitting the retrieved discussions for display on the user's device when the video time is within the associated pre-specified range.

6. The system of claim 1, wherein the program instructions further comprise storing social networking data for each user.

7. The system of claim 6, wherein the social networking data includes information on at least one of user friends, user groupings, user courses, user age, user personality, and user activity level.

8. The system of claim 1, wherein discussions comprise at least one of text data, video data, picture data, animation data, or audio data.

9. The system of claim 1, wherein the discussion is created by an instructor user.

10. The system of claim 1, wherein the discussion is created by a student user.

11. The system of claim 1, wherein the discussion is publicly viewable by other users.

12. The system of claim 10, wherein the discussion is viewable by other users having a specified association with the student user based on at least some of the student user's social networking data.

13. The system of claim 12, wherein the discussion is viewable only by the student user.

14. The system of claim 13, wherein the discussion is a user note/bookmark.

15. The system of claim 9, wherein the instructor-created discussion is used to conduct student assessment testing.

16. The system of claim 15, wherein the instructor-created discussion automatically pauses playback of the video when it is displayed.

17. The system of claim 1, wherein the program instructions further comprise automatically pausing playback of the video on the user device when the user indicates that the user wishes to respond to one of the at least one discussions.

18. The system of claim 17, wherein the user indicates that the user wishes to respond by selecting a response input box on a graphical user interface.

19. The system of claim 17, wherein playback of the video automatically resumes when the user submits a response to the discussion.

20. The system of claim 1, wherein the program instructions further comprise receiving a search term from the user, searching discussions for the search term, and transmitting search result discussions matching the search term to the user.

21. The system of claim 20, wherein the program instructions further comprise sorting the search result discussions based on a user-selected criteria.

22. The system of claim 1, wherein a graphical user interface contains a discussion pane for displaying at least one discussion associated with the video.

23. The system of claim 22, wherein the program instructions further comprise:
receiving an indicator from the user selecting one discussion in the discussion pane; and
automatically jumping the video playback to the video time index associated with the selected discussion when the indicator is received.

24. The system of claim 3, wherein the program instructions further comprise:
storing an e-commerce data;
associating the e-commerce data with a corresponding video segment topic when a subject of the e-commerce data is related to the video segment topic; and
transmitting the e-commerce data for display on the user's device when the video time is within the pre-specified range associated with the corresponding video segment topic.

25. The system of claim 3, wherein the program instructions further comprise:
storing at least one course document;
associating each course document with one of the video segment topic when a subject of the course document is related to the video segment topic; and
transmitting each course document for display on the user's device when the video time is within the pre-specified range associated with the video segment topic.

26. The system of claim 2, wherein the program instructions further comprise:
generating a notification when the at least one response is received; and
sending the notification to all users associated with the discussion.

27. The system of claim 26, wherein the program instructions further comprise:
receiving a notification response to the notification;
retrieving the notification response from the notification; and
appending the notification response to the discussion.

28. The system of claim 26, wherein the notification and notification response is sent via e-mail, instant message, short message service, or social networking message.

29. A computer-implemented method of video education, the computer comprising one or more programmable processors operatively connected to a video server and database, the method comprising:
storing, using at least one of the processors, a video on the video server;
storing, using at least one of the processors, at least one discussion on a database, each discussion being associated with a video time index;
streaming, using at least one of the processors, the video from the video server to a user device; and
transmitting, using at least one of the processors, at least one discussion for display on the user's device, each discussion being displayed when the video time is within a pre-specified range of the video time index for the discussion to be displayed.

30. The method of claim 29, further comprising:
receiving at least one response to the discussion; and
appending the response to the discussion.

31. The method of claim 29, further comprising setting the pre-specified range to correspond to a video segment topic.

32. The method of claim 31, further comprising associating the discussion with the video segment topic when the discussion relates to the video segment topic.

33. The method of claim 31, further comprising:
retrieving from the database all discussions associated with a currently playing video segment topic of the streaming video; and
transmitting the retrieved discussions for display on the user device when the video time is within the associated pre-specified range.

34. The method of claim 29, further comprising storing social networking data for each user.

35. The method of claim 34, wherein the social networking data includes information on at least one of user friends, user groupings, user courses, user age, user personality, and user activity level.

36. The method of claim 29, wherein discussions comprise at least one of text data, video data, picture data, animation data, or audio data.

37. The method of claim 29, wherein the discussion is created by an instructor user.

38. The method of claim 29, wherein the discussion is created by a student user.

39. The method of claim 29, wherein the discussion is publicly viewable by other users.

40. The method of claim 38, wherein the discussion is viewable by other users having a specified association with the student user based on at least some of the student user's social networking data.

41. The method of claim 40, wherein the discussion is viewable only by the student user.

42. The method of claim 41, wherein the discussion is a user note/bookmark.

43. The method of claim 37, wherein the instructor-created discussion is used to conduct student assessment testing.

44. The method of claim 43, wherein the instructor-created discussion automatically pauses playback of the video when it is displayed.

45. The method of claim 29, further comprising automatically pausing playback of the video on the user device when the user indicates that he wishes to respond to one of the at least one discussions.

46. The method of claim 45, wherein the user indicates that the user wishes to respond by selecting a response input box on a graphical user interface.

47. The method of claim 45, wherein playback of the video automatically resumes when the user submits a response to the discussion.

48. The method of claim 29, further comprising receiving a search term from the user, searching discussions for the search term, and transmitting search result discussions matching the search term to the user.

49. The method of claim 48, further comprising sorting the search result discussions based on a user-selected criteria.

50. The method of claim 29, wherein a graphical user interface contains a discussion pane for displaying at least one discussion associated with the video.

51. The method of claim 50, further comprising:
receiving an indicator from the user selecting one discussion in the discussion pane; and
automatically jumping the video playback to the video time index associated with the selected discussion when the indicator is received.

52. The method of claim 29, further comprising:
storing an e-commerce data;
associating the e-commerce data with the video segment topic when a subject of the e-commerce data is related to the video segment topic; and
transmitting the e-commerce data for display on the user's device when the video time is within the pre-specified range associated with the video segment topic.

53. The method of claim 29, further comprising:
storing at least one course document;
associating each course document with a corresponding video segment topic when a subject of the course document is related to the corresponding video segment topic; and
transmitting each course document for display on the user's device when the video time is within the pre-specified range associated with the corresponding video segment topic.

54. The method of claim 29, further comprising:
generating a notification when the at least one response is received; and
sending the notification to all users associated with the discussion.

55. The method of claim 54, further comprising:
receiving a notification response to the notification;
retrieving the notification response from the notification; and
appending the notification response to the discussion.

56. The method of claim 54, wherein the notification and notification response is sent via e-mail, instant message, short message service, or social networking message.
